(19) United States
(12) Patent Application Publication
(10) Pub. No.: US 2016/0203736 A1
(43) Pub. Date: Jul. 14, 2016

(54) Model Kit for Ionic Compounds

(71) Applicant: Benedict Aurian-Blajeni, Newport, RI (US)

(72) Inventor: Benedict Aurian-Blajeni, Newport, RI (US)

(21) Appl. No.: 14/793,993

(22) Filed: Jul. 8, 2015

Related U.S. Application Data
(60) Provisional application No. 62/103,013, filed on Jan. 13, 2015.

(51) Int. Cl. G09B 23/26

(52) U.S. Cl. CPC G09B 23/26

(57) ABSTRACT

A block model kit for representing validly constructed ionic compounds is provided. A valid ionic compound (formula unit) constructed with the block model kit is represented by a cuboid shape having six faces and eight corners and no more than two ionic types represented by blocks having ionic coding.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Applications) to the extent such subject matter is not inconsistent herewith:

U.S. provisional patent application 62/103,013 entitled “Model Kit for Ionic Compounds”, naming Benedict Aurian-Blajeni as inventor, filed 13 Jan. 2015.

### BACKGROUND

1. Field of Use

The present invention relates generally to models used for representing atoms and molecules, and in particular to a novel and improved model of this type including provision for ionic compounds, as formula units.

2. Description of Prior Art (Background)

Atoms are the basic chemical unit of matter. Atoms comprise a positive nucleus and one or more electrons surrounding the nucleus. Chemical compounds are formed by atoms connected by chemical bonds, in fixed proportions. Chemical compounds are often represented by physical models for instruction and visualization purposes.

Many patents are directed to such molecular models. For example U.S. Pat. No. 2,974,425, patented March 1961, by Dreiding, included a large number of different model building components. Since the components were formed from machined steel they were inflexible and thus models of certain molecules and compounds could not be constructed therefrom. In addition, inasmuch as machined steel was utilized, the overall cost of the set was quite high and could not be afforded by students and the like.

U.S. Pat. No. 3,080,662, patented Mar. 2, 1963, by Bramlik, proposed to provide a chemical model which was capable of representing the volume orbitals and of demonstrating their spatial arrangement and interactions so as to exemplify the important role which they played in chemical reactions. The patentee also proposed to provide a chemical model which was capable of representing the greatest number of molecules, radicals and ions with the smallest number of different piece-types, so as to minimize the cost of a model set of any given size. By means of his inventive concept, the patentee proposed to provide a model assembly for representing the atomic and molecular orbital structure of atoms in a molecule. The assembly included at least one body representing the atom core, at least one body shaped to represent the three dimensional character of an atomic orbital, and means for selectively connecting the bodies the depict an atom having at least on unshared electron pair orbital.

Canadian Patent No. 712,758, patented Jul. 6, 1965, by Bramlik, proposed to provide a molecular model assembly which comprised a plurality of coupling units each represented the center and the directed valence orbitals of a single atom. Each had arm sections angularly arranged in accordance with the symmetry axes of valence orbitals and bond angles of the atom to be depicted by the coupling unit. A plurality of elongated cylindrical sections were provided, each being sized for frictional-mounting at each end on respective arm sections of the coupling units. The cylindrical sections were respectively sized to represent accurately to scale the sigma bond distances between bonded atoms represented by the coupling units, and the Van der Waal's radii of unshared electron pair orbitals, pi orbitals and polynuclear pi orbitals. The cylindrical sections were color-coded respectively to depict atoms of selected elements. The coupling units and cylindrical sections were thus capable of being coupled to form an accurate frame work model of a selected molecule including accurate scale representations of bond angles, bond distances, covalent radii, and Van der Waal's radii.

U.S. Pat. No. 3,230,643, patented January 1966, by Mathus, provided a combination of plastic parts tor the atoms and metal tubing for the bonds. This set required the gluing of the plastic parts which comprised the atoms. Since the bonds were represented by metal tubing, the resulting molecule model members were relatively inflexible which resulted in the fracturing of these members across the glue line when the metal tubing was stressed. In addition, because of this inflexibility, the models of a number of different, organic molecules and compounds, such as those requiring less than a five member ring, could not be formed.

U.S. Pat. No. 3,333,349, patented Aug. 1, 1967, by Bramlik, provided a large number of different components and utilized tubing to connect such components. Since the user had to cut the tubing for his own needs, it was very possible that incorrect lengths would be cut which would result in the formation of a model of a molecule or compound with an incorrect spatial relationship between the atoms. In this case, dimensional accuracy between atoms would not exist and the resulting molecule or compound may have been impossible of actual existence.

U.S. Pat. No. 3,510,962, patented May 12, 1970, by Sato, attempted to solve two problems. The first problem to be met consisted of how to orient the various bond angles of the model to represent the actual bond angles of the molecules. The second problem resided in the connections between the spherical and polyhedral ball members and the bond members. A tight but rotatable telescopic engagement of these members was required. The patentee provided a molecular structure educational model for use in teaching stereo-chemistry comprising polyhedral block members each having fourteen facets and a cubic configuration with eight corners cut away along the straight lines connecting the centers of the adjacent ones of the twelve edges forming six square facets and eight equilateral triangular facets. Every pair of opposite facets of each polyhedral block member was parallel to each other, and each of the facets had a hole in the center thereof perpendicular to the plane of the facet. Rod members were insertable in the holes to interconnect the polyhedral block members.

Canadian Patent No. 871,230, patented May 18, 1971, by Bramlik, proposed to provide molecular orbital models by means of a model assembly for representing the atomic and molecular orbital structure of atoms in a molecule. The assembly comprised a plurality of units which represented atom cores, each of the units comprised a solid body having the form of a polyhedron with triangular planar faces and with a bore at each corner thereof arranged in accordance with the symmetry axes of the valence orbitals and bond angles of the atom to be depicted by the unit, the bodies of the plurality of atom core units were of three types respectively defining a tetrahedron, a trigonal bipyramid and an octahedron depicting the forms of the hybridization states of a single atom. A plurality of such units represented atomic orbital lobes and each comprises a hollow body of substantially ellipsoid-shape which had a terminal bore. Coupling means were provided in the form of elongated members which had end portions sized for frictional-mounting within the bores of the atom core unite and orbital lobe units for interconnecting selected atom core units and for connecting selected orbital lobe units to the atom core units to form semi-skeletal models of selected molecules including scale representations of bond angles, bond distances, atomic orbitals and internuclear distances, with the molecules shown in ground states and excited states.

Canadian Patent No. 907,320, patented Aug. 15, 1972, by Forsstrom, attempted to provide a construction series for molecular models which comprised, in combination, a first unit in the form of a spherical segment which had a spherical surface of a size substantially greater than a semi-sphere, and which had a flat surface formed with a recess on the flat surface for receiving a portion of a spherical surface of another unit. An interchangeable member, extended from the bottom of the recess centrally of the recess and approximately to the flat surface. The spherical surface of the first unit was formed with at least one aperture which had a cross-section corresponding to that of the cross-section of the interchangeable member. Two units could thus be joined by inserting the interchangeable member of the first unit into an aperture of the other unit.

Canadian patent No. 949,311, patented Jun. 18, 1974, by Nicholson, proposed to provide a model representing a molecular structure which comprised atoms and interatomic bonds. A unit, which represented a multivalent, atom comprised a spherical body which had a single socket which comprised a cylindrical hole of circular cross-section diametrically-extending of the body with a depth greater than the radius of the body and a plurality of integral arms radiating from the body. Each of the atoms had a portion of polygonal cross-section at the sphere and the number of arms was one less than the valence number of the atom represented. The socket and the arms were oriented relative to one another at substantially the correct valency angles of the atom, each arm had, at its free end, a cylindrical portion, of a diameter tightly to fit into a like socket of another unit of the model and a length at least as great as the depth of the socket. In this way, a plurality of units were assembled with an integral arm of one unit fitting into the socket of another unit without play to form a substantially-rigid structure.

U.S. Pat. No. 4,020,656, patented May 3, 1977, by Dreiding, proposed to provide a set of structural elements for forming stereo-chemical models of molecular bonds between polyvalent atoms. Each structural element had at least two connector arms representing the valences of at least one atom. Each of the connector arms had opposite inner and outer and portions and were coupled at its inner end portion with a corresponding end portion of at least one other of the connector arms of the same structural element. The outer of each connector arm comprised manually-operably means for pair-wise equiaxial coupling and uncoupling the arm to or from a corresponding outer end portion of another connector arm of the same structural element or of another one of the structural elements. The means for pair-wise coupling and uncoupling the outer end portions of the connector arms comprised identically-designed coupling devices at each outer end portion of all connector arms. The coupling devices were configured for direct coupling of any two outer end portion of all connector arms without auxiliary means, the connector arms each comprised a flexible element which was normally rectilinear when unloaded.

Canadian Patent No. 1,147,143, patented May 31, 1983, by LeBlanc, attempted to provide a model assembly which comprised two spaced spheres which represented carbon atoms. Each sphere carried a fixed blade extending toward the other sphere with the fixed blades representing a hybridized “sp²” orbital, and each sphere carried a blade representing an unhybridized. “p” orbital movable in a first plane toward the other sphere to at least partially overlap or contact the corresponding blade carried by the other sphere which had been moved toward the first sphere in the first plane. Each sphere carried a pair of blades which each represented hybridized “sp²” orbitals and which were simultaneously-movable in a second plane which was normal to the first plane. In each sphere the inner end of the blade which represented the hybridized “p” orbital was interconnected with the inner ends of the blades movable in the second plane which represented hybridized “sp²” orbitals whereby movement of the unhybridized “p” orbital blade towards the other sphere resulted in simultaneous movement of the related pair of hybridized “sp²” orbitals away from the other sphere to a position in the second plane where the three hybridized “sp²” blades were separated by 120°.

U.S. Pat. No. 4,398,888, patented Aug. 16, 1983, by Darling et al., proposed to provide a molecular model building member which comprised a first end portion, a second end portion, and two arms connecting the first end portion and the second end portion, each of the two arms were substantially-symmetrical about its axis. The first end portion and the second end portion each had an opening formed therein to receive another molecular model building member to form a model of a molecule. Each of the first and second end portions had a projection formed thereon oppositely-directed from the opening formed therein. The opening was provided with inwardly-extending lips of the entrance thereto for engagement with the projection provided on another molecular model building member to interlock with the other molecular model building member when received within the opening adjacent the inwardly-extending lips.

Canadian Patent No. 1,179,497, patented Dec. 18, 1984, by Barrett, proposed to provide an interlocking molecular model system which comprised: a first component representative of an atom and which included at least one elongated shank outwardly-extending from a part of the component which represented the nucleus of the atom. The shank had a first cylindrical section of one cross-sectional area at its outer end, a second cylindrical section of smaller cross-sectional area adjacent the end of the first cylindrical section which faced the part of the component which represented the nucleus, the surface of the shank between the first and second cylindrical sections defined a shoulder inwardly-extending from the surface of the first cylindrical section, and an abutment extending transversely-outwardly relative to the axial direction of the second cylindrical section and adjacent to the end of the second cylindrical section closer to the part of the component which represented the nucleus. A fastener component was provided which comprised a hollow tubular position longitudinally-slotted at one end and had an axial length representative of a predetermined portion of a covalent radios of the atom, the inner surface at one end of the slotted end portion comprised an inwardly-extending axial lock which fit over the second cylindrical section of the first component to be booked behind the shoulder on the shank and had an axial length substantially equal to the axial length of the second cylindrical section. The fastener component could thus be axially-interlocked with the shank so that the distance between the part of the first component which represented the nucleus and the remote end of the tubular portion of the fastener component was representative of the covalent radius of that atom, and the inner surface of the part of the tubular position between the axial lock and the remote end had a cross-sectional area large enough to fit over the first cylindrical section.

U.S. Pat. No. 4,325,698, patented Apr. 28, 1987, by Darling et al., and its corresponding Canadian Patent No. 1,167,637 patented May 22, 1984, proposed to provide a molecular model building member which comprised a main portion with two arms connected to and emanating outwardly from the main portion. The member was formed of relatively flexible material which permitted the arms to be bendable relative to the main portion. One of the arms was comprised of a first section connected to the main portion and a second section connected to the first section so that the first section was interposed between the main portion and the second section. The second section of one of the arms had an annular rib around the periphery thereof and had a smaller cross-section than the first section so as to form a first annular shoulder at their intersection. The other of the arms had a bore therein to receive the second section of the one of the arms of another of the molecular model building members and to frictionally-engage the annular rib provided thereon.

While the prior art is replete with various chemical models the prior art lacks a model for portraying the construction of chemical compounds formed by interatomic ionic bonds.

Chemical compounds are said to be ionic bonded when electrons (having a negative charge) are transferred between atoms, as opposed to covalent bonding when electrons are shared by atoms. Atoms that are ionic bonded are ions (electrically charged atoms) held together by electrostatic forces; e.g., a positive ion (cation) ionic bonded with a negative ion (anion). Typically, the most common charge on cations are +1, +2, and +3. The most typical common anionic charges are −, −2, and −3.

Ionic compounds are electrically neutral (the number of positive charges equals the number of negative charges). The basic unit of an ionic compound that contains the minimum possible number of cations and anions in the appropriate ratio is defined as a formula unit.

As noted earlier, there is a need for a model to illustrate and visualize the construction of ionic compounds.

### BRIEF SUMMARY

In accordance with one embodiment of the present invention a system of complementary and coded cuboids (blocks) is provided for modelling valid ionic compound constructs. Some of the blocks are fitted with posts to represent anions and other blocks are fitted with wells to represent cations. The blocks may be coded by any suitable method such as color coding for visual identification, or embossing/engraving for tactile identification. A valid ionic compound construct is represented by an equal number of posts and wells; representing electrical neutrality of a formula unit.

In accordance with one embodiment of the invention a cuboid model kit for representing validly constructed ionic compounds is provided. The kit includes a first rectangular (square) cuboid model representing (+1) cation, wherein the first square cuboid model includes a hole (well) positioned at a center of one face of the first square cuboid model; and a second square cuboid model representing (−1) anion, wherein the second square cuboid model, includes a post positioned at the center of one face of the second square cuboid model. The first square cuboid model and the second square cuboid model are dimensionally equal. Also included is a rectangular cuboid model representing (+2) cation, wherein the third rectangular cuboid model includes two holes (wells) positioned on one face of the third rectangular cuboid model; and a fourth rectangular cuboid model representing (−2) anion, wherein the fourth rectangular cuboid model includes two posts positioned on one face of the forth rectangular cuboid model. The third and the fourth rectangular cuboid models are twice the dimensional length of the first or second square cuboid models. A fifth rectangular cuboid model representing (−3) anion also includes three posts positioned on one face of the fifth rectangular cuboid model; and a sixth rectangular cuboid model representing (+3) cation, wherein the sixth rectangular cuboid model includes three holes (wells) positioned on one face of the sixth rectangular cuboid model. The fifth and the sixth rectangular cuboid models are thrice the dimensional length of the first or second square cuboid models. All posts and wells are complementarily located such that when fitted together the models form yet another cuboid.

The invention is also directed towards a cross learning modality ionic compound representation model kit. The model kit includes first and second models representing (+1) cation and (−1) anion, respectively. Each model includes a first visual coding for stimulating visual learning modality and wherein the first visual coding comprises a first color coding. Each first and second models comprises a 1-unit cuboid, wherein the (+1) cation unit cuboid comprises one well and the (−1) anion unit cuboid comprises one post. Also included are third and fourth models representing (+2) cation and (−2) anion, respectively. Each third and fourth model include a second visual coding for stimulating visual learning modality and wherein the second visual coding comprises a second color coding. Each third and fourth models comprise a 2-unit cuboid, wherein the (+2) cation 2-unit cuboid comprises two second wells and the (−2) anion 2-unit cuboid comprises two second posts. The fifth and sixth models represent (+3) cation and (−3) anion, respectively. Each of the fifth and sixth models comprise a third visual coding for stimulating visual learning modality, wherein the third visual coding comprises a third color coding. Each fifth and sixth models comprise a 3-unit cuboid, wherein the (+3) cation 3-unit cuboid comprises three third wells and the (−3) anion 3-unit cuboid comprises three third posts. The first, second, third, fourth, fifth, or sixth models are adaptable to fit together to form a tactile cuboid having 6 faces and 8 corners, the tactile cuboid having one or two color coding therein representing a valid ionic compound.

### BRIEF DESCRIPTION OF THE DRAWINGS

FIG. 1A and FIG. 1B are perspective views of a positively charged square cuboid model (+1) cation and a negatively charged square cuboid model (−1) anion, respectively;

FIG. 2A and FIG. 2B are perspective views of a positively charged rectangular cuboid model (+2) cation and a negatively charged rectangular cuboid model (−2) anion, respectively;

FIG. 3A and FIG. 3B are perspective views of a positively charged rectangular cuboid model (+3) cation and a negatively charged rectangular cuboid model (−3) anion, respectively;

FIG. 4 is a pictorial block model example of the ionic compound between a (+2)-cation and two (−1) anions (e.g. calcium (calcium ion (+2)) and chlorine (chloride ion (−1));

FIG. 5 is a pictorial block model example of a positively charged (+1) ion coupled with a negatively charged (−1) ion (e.g. sodium (sodium ion (+1)) and chlorine (chloride ion (−1));

FIG. 6 is a pictorial block model example of three blocks representing one-charged ions electrically balanced by single block three-charged ion (+ or −3);

FIG. 7 is a pictorial block model example of a positively charged (+2) ion coupled with a negatively charged (−2) ion;

FIG. 8 is a pictorial block model example of a positively charged (+3) ion coupled with a negatively charged (−3) ion;

FIG. 9 is a pictorial block model example of an invalid ionic construct having two dissimilar cations (or anions);

FIG. 10 is a periodic table of the elements coded to represent ions corresponding to the ion block models; and

FIGS. 11A, 11B, and 11C are tables of polyatomic ions representable by the ion block models.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

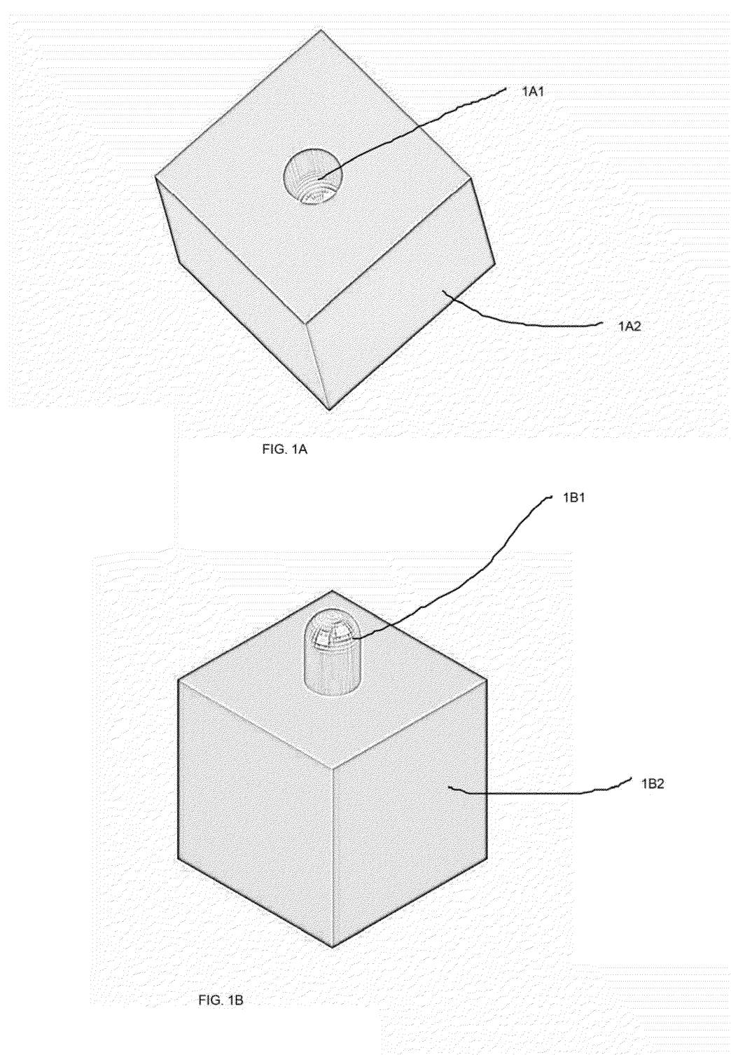

Referring now to the figures it is shown that the present invention includes a system of complementary blocks for modeling the formula unit of ionic compounds. Blocks representing anions are shown in FIGS. 1B, 2B, and 3B as blocks with posts (e.g. FIG. 1B-3B). Blocks representing cations are shown in FIGS. 1A, 2A, and 3A as blocks with wells (e.g. FIG. 1A-3A). The blocks are also coded, e.g., color coded, to visually represent the ion's electrical charge (+/−1, +/−2, and +/−3), or coded by engraving or embossing for tactile representation. A valid model representation of an ionic compound may have up to two colors and must be electrically neutral in other words the number of posts must equal the number of wells.

Referring also to FIG. 1A and FIG. 1B there are shown perspective views of a positively charged block model (+1) cation and a negatively charged (−1) anion block model, respectively. It will be appreciated the block models may be any suitable material such as metal, plastic, or wood. Still referring to FIG. 1A and FIG. 1B, well 1A1 is located on a face of block 1A2 such that the well aligns with post 1B1 located on block 1B2. It will be appreciated that the block models may be coded (e.g., color coded) to visually represent the ionic charge. For example, the +1, −1 model blocks may be color coded blue. In alternate embodiments the cation (wells) and anion (posts) blocks may be oppositely magnetized to provide tactile representation of the electrostatic force coupling the ions to form the ionic compound. It will be appreciated that the size of the +1 cation and −1 anion are substantially the same size for all dimensions and are the dimension reference blocks for the (+2, −2) and (+3, −3) ions.

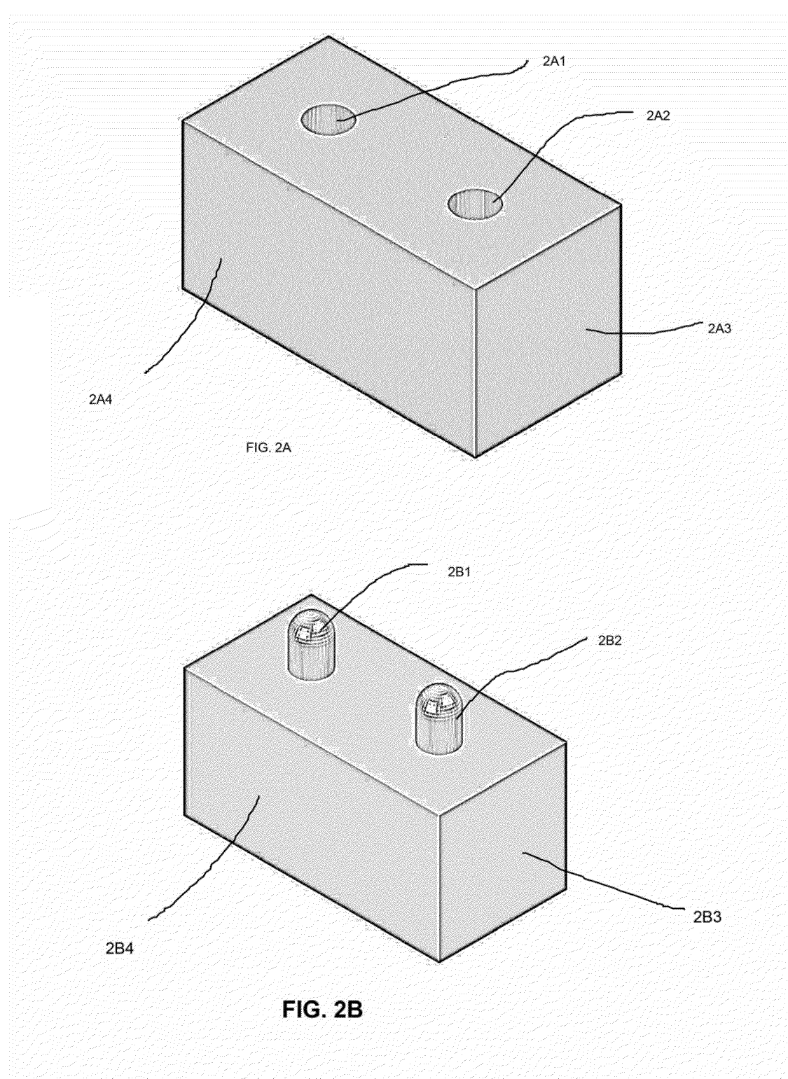

Referring also to FIG. 2A and FIG. 2B there are shown perspective views of a positively charged block model (+2) cation and a negatively charged (−1) anion block model, respectively. It will be appreciated the block models may be any suitable material such as metal, plastic, or wood. Still referring to FIG. 2A and FIG. 2B, well 2A1 is located on a face of block 2A such that the well aligns with post 2B1 located on block 2B. Likewise, well 2A2 is located on a face of block 2A such that the well aligns with post 2B2 located on block 2B. It will be appreciated that each positively charged block model (+2) cation and a negatively charged (−2) anion block model is substantially twice the length of the +1 cation or −1 anion block models, and the same height and width, it will be appreciated that the block models may be coded (e.g., color coded) to visually or tactilely represent the ionic charge. For example, the +2, −2 model blocks may be color coded yellow. It will also be appreciated that for alternate embodiments the cation and anion blocks may be oppositely magnetized to provide tactile representation of the electrostatic force coupling the ions to form the ionic compound. The posts on any of the blocks 1B-3B would complement any of the wells in any of the blocks 1A-3A, as far as size and position are concerned.

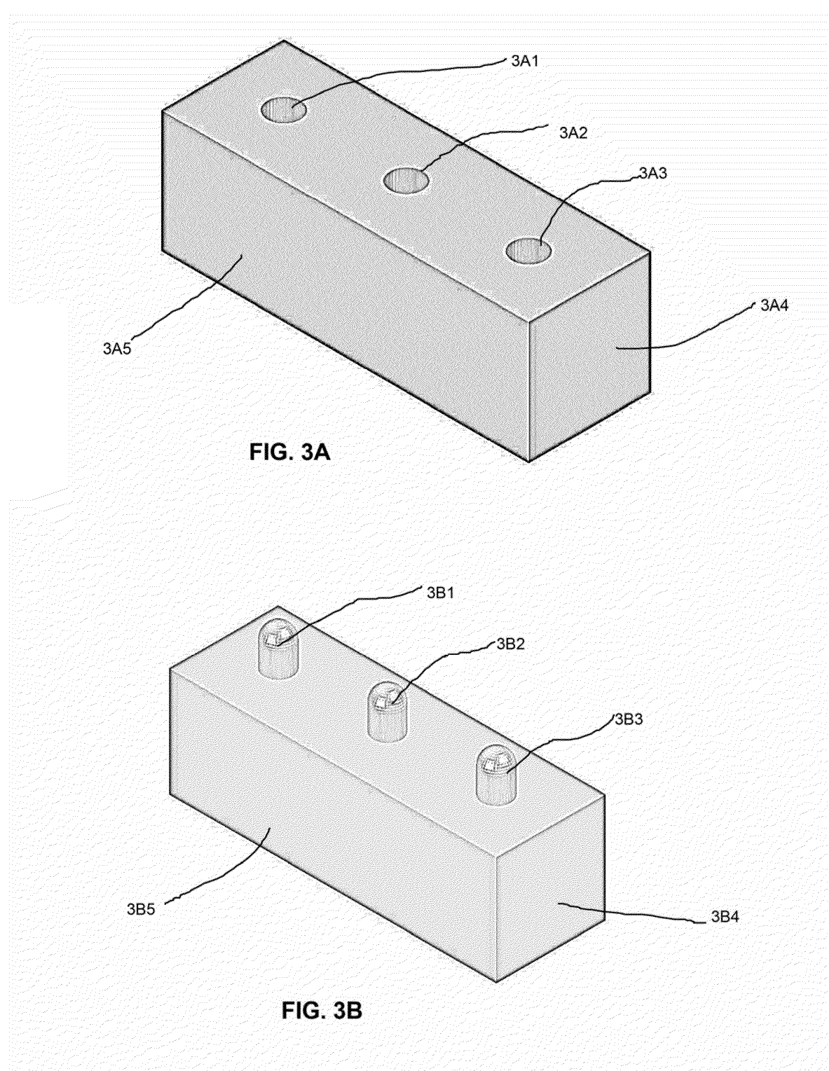

Referring also to FIG. 3A and FIG. 3B there are shown perspective views of a positively charged block model (+3) cation arid a negatively charged (−3) anion block model, respectively. It will be appreciated the block models may be any suitable material such as metal, plastic, or wood. Still referring to FIG. 3A and FIG. 3B, well 3A1 is located on a face of block 3A4 such that the well aligns with post 3B1 located on block 3B4. Likewise, well 3A2 is located on a face of block 3A4 such that the well aligns with post 3B2 located on block 3B4. Similarly, well 3A3 aligns with post 3B3. It will be appreciated that each positively charged block model (+3) cation and a negatively charged (−3) anion block model is substantially thrice the length of the +1 cation or −1 anion block models, respectively. It will be appreciated that the block models may be coded. For example, the blocks may be color coded to visually represent the ionic charge, and/or embossed or engraved for tactile representation (grooves, depressions). The grooves and/or depressions may be coded to represent information about the block (e.g., Morse and/or Braille code). For example, the +3, −3 model blocks may be color coded red. It will also be appreciated that for alternate embodiments the cation and anion blocks may be oppositely magnetized to provide tactile representation of the electrostatic force coupling the ions to form the ionic compound.

As shown herein a valid representation of a formula unit uses a combination of the ion block models, assembled according to the following criteria:
a. The model of the formula unit has a rectangular box (cuboid) shape (eight corners, six faces). This ensures that the formula unit has a zero net charge.
b. The model of the formula unit has one or, at most, two ion charge types. This criterion ensures that the formula unit comprises one type of cations and one type of anions.

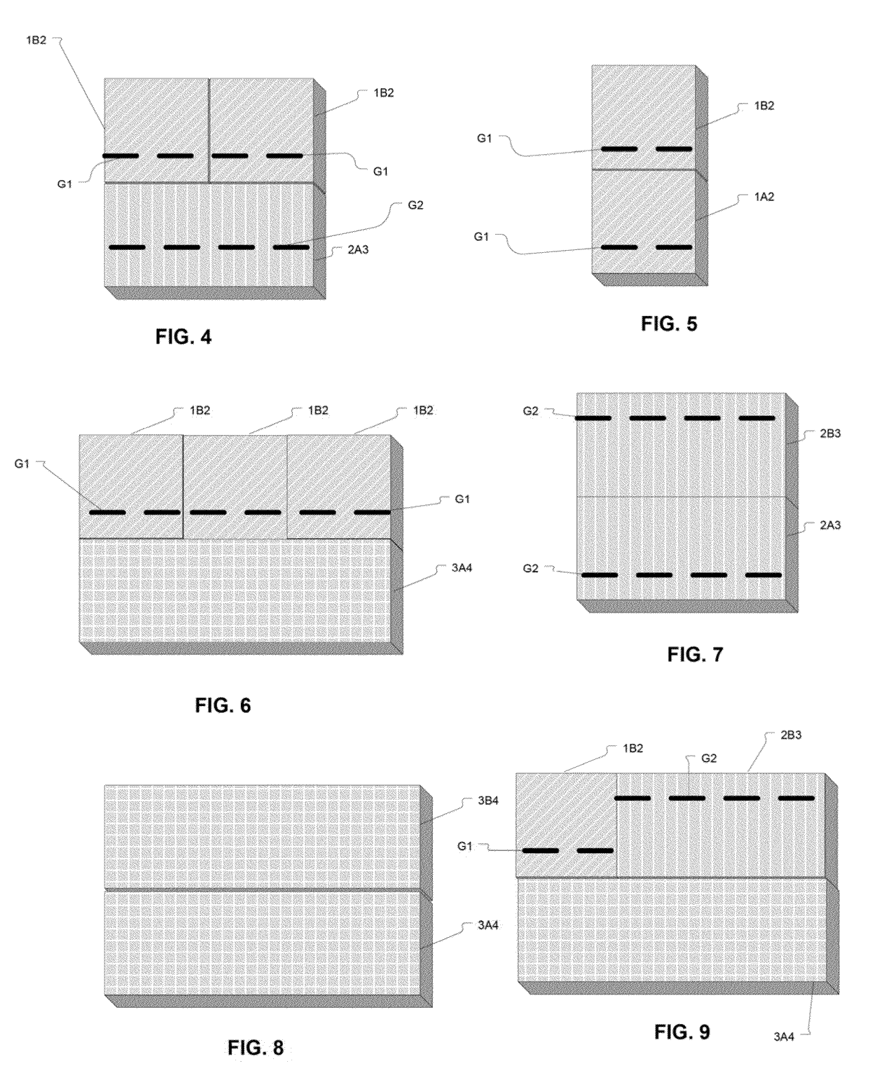

Referring also to FIG. 4 there is shown a pictorial block model example of the ionic compound made of one (+2) block and two (−1) blocks (e.g. calcium (calcium ion (+2)) and chlorine chloride ion (−1) to form calcium chloride). In this representation the chloride ions are represented by blocks 1B2 and the calcium ion is represented by block 2A3. It will be appreciated that the two chloride ions, each having a −1 charge electrically balance the calcium ion having a +2 charge.

Also shown in FIG. 4 is tactile learner modality device G1. The tactile learner modality device G1 may be any suitable device such as alignment grooves which align with other tactile learner modality device G1s when a valid ionic compound representation is constructed. The tactile learner modality device G1 may include depressed coding which serves two purposes: one alignment with other G1 coding and coding conveying information about the block (e.g., Braille code representing type (cation or anion) and charge).

Still referring to FIG. 4 there is shown tactile learner modality device G2. The tactile learner modality device G2 may be any suitable device such as alignment grooves which misalign with tactile learner modality device G1s when an invalid ionic compound representation is constructed. The tactile learner modality device G2 may include depressed coding which serves two purposes: one misalignment with G1 coding and coding conveying information about the block (e.g., Braille code representing type (cation or anion) and charge).

Referring also to FIG. 5 there is shown a pictorial block model example of a positively charged (+1) ion 1A coupled with a negatively charged (−1) ion 1B (e.g. sodium (sodium ion, Na⁺), and chlorine (chloride ion, Cl⁻) to form sodium chloride (NaCl)). It will be appreciated that each of the ions are similarly coded to represent the single electron charge.

Referring also to FIG. 6 there is shown a pictorial block model example of three negatively charged ions 1B electrically balanced by a single block representing a charged ion (+3), 3A. It will be appreciated that FIG. 6 is a valid ionic compound construct: only two block codes (in this example hash marks and slanted lines), eight, corners (only four showing for simplicity), and six faces.

Referring also to FIG. 7 there is shown a pictorial block model example of a positively charged (+2) ion, 2A, coupled with a negatively charged (−2, 2B. FIG. 7 is also a valid ionic compound construct: one block code (vertical lines), eight corners, and six faces.

Referring also to FIG. 8 there is shown a pictorial block model example of a positively charged (+3) ion, 3A, coupled with a negatively charged (−3) ion, 3B. FIG. 8 is also a valid ionic compound construct: one block code (hash lines), eight corners, and six faces.

FIG. 9 is a pictorial block model example of an invalid ionic construct having two dissimilar cations (or anions) and an anion (or cation). As shown in FIG. 9 this ionic compound construct fails the ionic construction criteria: more than two coded ion blocks (slants, vertical lines, and hash lines).

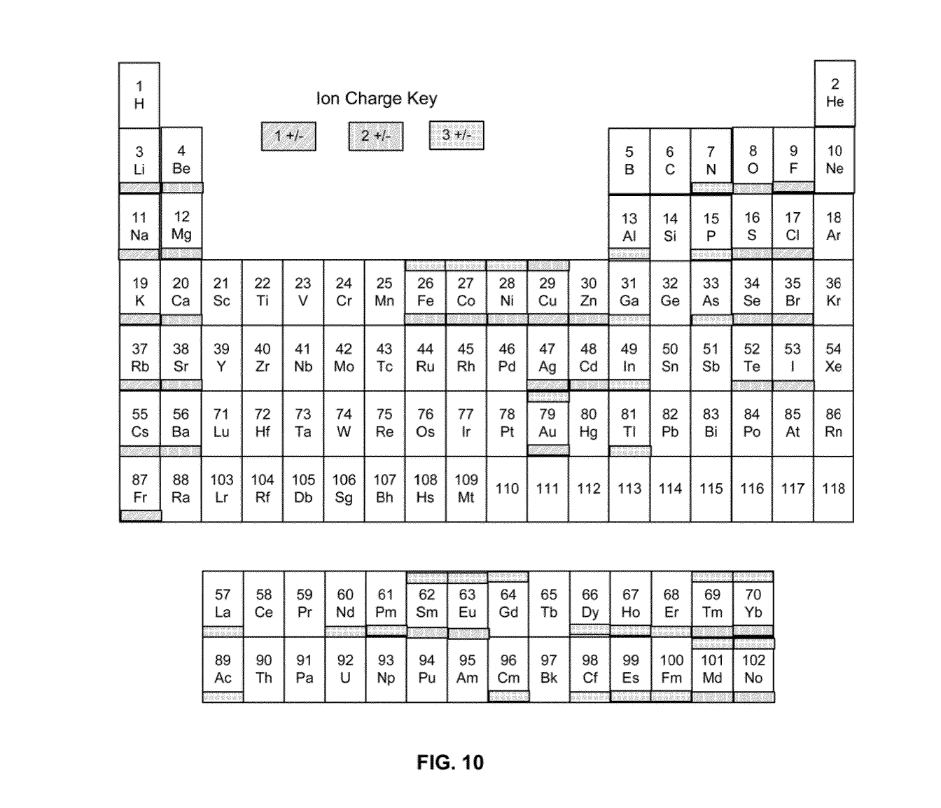

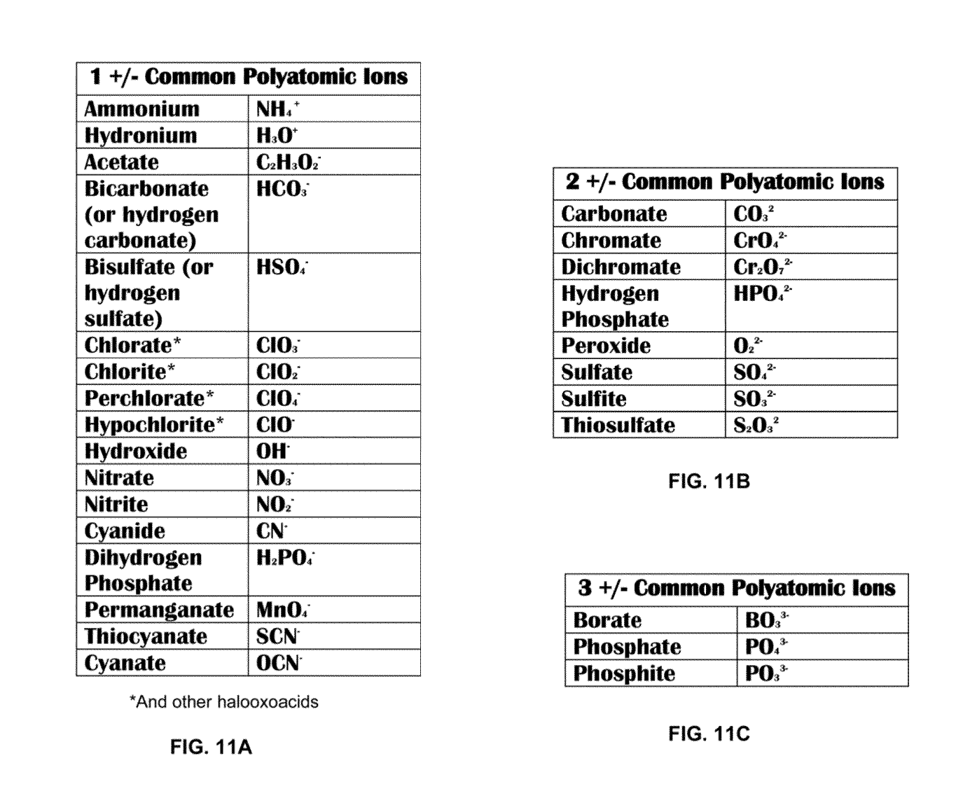

It will be appreciated that approximately twenty-five hundred ionic compounds may be represented by the ion block models shown in FIGS. 1A, 1B, 2A, 2B, 3A, and 3B. The ions that may be represented by the ion block models are shown in FIG. 10. Formula units for balanced combinations of two ions may also be constructed using the polyatomic ions shown in FIG. 11.

It will be appreciated that the blocks may be manufactured from any suitable material such as, for example, wood, or plastic. In addition, the blocks may be any suitable size constrained only by the following dimension rules. The length of a 2 charge, positive or negative, block model (FIGS. 2A, 2B) must be substantially twice the length of a 1 charge, positive or negative, block model (FIGS. 1A, 1B). The length of a 3 charge, positive or negative, block model (FIGS. 3A, 3B) must be substantially three times the length of a 1 charge, positive or negative, block model (FIGS. 1A, 1B). The other two dimensions (width, height) must be substantially the same for all block models. In addition, the posts and wells for each block model must be symmetrically located such that a post one block will align with a well on another block.

It will be appreciated that the invention presented herein represents a system and method for teaching ionic bonding across visual and tactile learning modalities (perception, memory, and sensation). Visual modality is addressed by visually coding the cuboid models. For example, the +1 cations and −1 anions may be color coded differently than the +2 cations and −2 anions and the +3 cations and −3 anions. Thus, according to the rules of construction previously discussed, no more than two colors may be used to construct a valid ionic compound.

Similarly, tactile learning modalities are addressed by alignment grooves (FIGS. 4-7: G1, G2) and/or aligned coded depressions (e.g., Braille code) and/or magnetic attraction or repulsion.

It should be understood that the foregoing description is only illustrative of the invention. Accordingly, the present invention is intended to embrace all such alternatives, modifications and variances which lull within the scope of the appended claims. For example, any complementary shape of posts and wells may be used, e.g., triangular, oval, square, or hexagonal. Similarly the blocks and posts may be composed of any suitable material such as wood, plastic, or composites, for example; or, a combination of said materials. Similarly, the posts and corresponding wells may be suitably located anywhere on the face of a block, e.g., other than face center.

What is claimed is:

1. cuboid model kit for representing validly constructed ionic compounds, the kit comprising:
a first square cuboid model representing (+1) cation, wherein the first square cuboid model comprises:
a hole (well) positioned at the center of one face of the first square cuboid model;
a second square cuboid model representing (−1) anion, wherein the second square cuboid model comprises:
a post positioned at the center of one lace of the second square cuboid model;
wherein the first square cuboid model and the second square cuboid model are dimensionally equal, except for wells and posts, respectively;
a third rectangular cuboid model representing (+2) cation, wherein the third rectangular cuboid model comprises:
two holes (wells) positioned on one face of the third rectangular cuboid model;
a fourth rectangular cuboid model representing (−2) anion, wherein the fourth rectangular cuboid model comprises:
two posts positioned on one face of the fourth rectangular cuboid model;
wherein the third and the fourth rectangular cuboid models are twice the dimensional length of the first or second square cuboid models;
a fifth rectangular cuboid model representing (−3) anion, wherein the fifth rectangular cuboid model comprises:
three posts positioned on one face of the fifth rectangular cuboid model;
a sixth rectangular cuboid model representing (+3) cation, wherein the sixth rectangular cuboid model comprises:
three holes (wells) positioned on one face of the sixth rectangular cuboid model; and
wherein the filth and the sixth rectangular cuboid models are thrice the dimensional length of the first or second square cuboid models.

2. The cuboid model kit in claim 1, wherein the cuboid models are visually coded to stimulate visual learning modality when a valid ionic compound is constructed, wherein:
the first and the second cuboid models are color coded a first color;
the third and the fourth rectangular cuboid models are color coded a second color;
the fifth and the sixth rectangular cuboid models are color coded a third color.

3. The cuboid model kit in claim 1, wherein the cuboid models are tactically coded to stimulate tactile learning modality when a valid ionic compound is constructed, wherein:
the first and second cuboid models are embossed with at least one first alignment device; and
the third and the fourth rectangular cuboid models are embossed with at least one second alignment device.

4. The cuboid model kit as in claim 3 wherein;
the at least one first alignment device comprises a first alignment groove; and
the at least one second alignment device comprises a second alignment groove offset from the at least one first alignment groove by a predetermined distance.

5. The cuboid model kit as in claim 4 wherein the at least one first alignment groove comprises a plurality of depressions.

6. The cuboid model kit as in claim 5 wherein the plurality of depressions conveys coded information about the first or second cuboid model.

7. The cuboid model kit as in claim 4 wherein the at least one second alignment groove comprises a plurality of depressions.

8. The cuboid model kit as in claim 7 wherein the plurality of depressions conveys coded information about the first or second rectangular cuboid model.

9. The cuboid model kit as in claim 1 wherein the cations and anions are oppositely magnetized to stimulate tactile learning modality.

10. A cross learning modality ionic compound representation model, the model comprising;
first and second models representing (+1) cation and (−1) anion, respectively;
third and fourth models representing (+2) cation and (−2) anion, respectively;
and
fifth and sixth models representing (+3) cation and (−3) anion, respectively.

11. The cross learning modality ionic compound representation model as in claim 10 wherein;
the first and second models representing (′1) cation and (−1) anion, respectively, each comprise a first visual coding for stimulating visual learning modality, wherein the first visual coding comprises a first color coding;
the third and fourth models representing (+2) cation and (−2) anion, respectively, each comprise a second visual coding for stimulating visual learning modality, wherein the second visual coding comprises a second color coding; and
the third and fourth models representing (+3) cation and (−3) anion, respectively, each comprise a third visual coding for stimulating visual learning modality, wherein the third visual coding comprises a third color coding.

12. The cross learning modality ionic compound representation model as in claim 11 wherein:
the first and second models representing (+1) cation and (−1) anion, respectively, each comprise a 1-unit cuboid, wherein the (+1) cation unit cuboid comprises one first well and the (−1) anion unit cuboid comprises one first post;
the third and fourth, models representing (+2) cation and (−2) anion, respectively, each, comprise a 2-unit cuboid, wherein the (+2) cation 2-unit cuboid comprises two second wells and the (−2) anion 2-unit cuboid comprises two second posts;
the fifth and sixth models representing (+3) cation and (−3) anion, respectively, each comprise a 3-unit cuboid, wherein the (+3) cation 3-unit cuboid comprises three third wells and the (−3) anion 3-unit cuboid comprises three third posts; and
wherein the first, second, third, fourth, fifth, or sixth models are adaptable to fit together to form a tactile cuboid having 6 faces and 8 corners, the tactile cuboid having one or two color coding therein representing a valid ionic compound.

13. The cross learning modality ionic compound representation model as in claim 10 wherein:
the first and second models representing (+1) cation and (−1) anion, respectively, each comprise a first tactile coding for stimulating tactile learning modality, wherein the first tactile coding comprises a first tactile coding, wherein the first tactile coding comprises a first alignment groove;
the third and fourth models representing (+2) cation and (−2) anion, respectively, each comprise a second tactile coding for stimulating tactile learning modality, wherein the second tactile coding comprises a second tactile coding, wherein the second tactile code comprises a second alignment groove offset from the first alignment groove by a predetermined distance.

14. The cross learning modality ionic compound representation model as in claim 10 wherein:
the first and second models representing (+1) cation and (−1) anion, respectively, each comprise a 1-unit cuboid, wherein the (+1) cation unit cuboid comprises one first well and the (−1) anion unit cuboid comprises one first post;
the third and fourth models representing (+2) cation and (−2) anion, respectively, each comprise a 2-unit cuboid, wherein the (+2) cation 2-unit cuboid comprises two second wells and the (−2) anion 2-unit cuboid comprises two second posts;
the fifth and sixth models representing (+3) cation and (−3) anion, respectively, each comprise a 3-unit cuboid, wherein the (+3) cation 3-unit cuboid comprises three third wells and the (−3) anion 3-unit cuboid comprises three third posts; and
wherein the first, second, third, fourth, fifth, or sixth models are adaptable to form a tactile cuboid having 6 faces and 8 corners, the tactile cuboid having aligned alignment grooves therein representing a valid ionic compound.

15. The cross learning modality ionic compound representation model as in claim 14 wherein fee first and second alignment grooves each comprise a plurality of coded depressions, wherein the first, second, third, fourth, fifth, or sixth models are adaptable to form a tactile cuboid having 6 faces and 8 corners, the tactile cuboid aligned according to the plurality of coded depressions.

16. A cross learning modality ionic compound representation model, the model comprising;
first and second models representing (+1) cation and (−1) anion, respectively, wherein each comprise a first visual coding for stimulating visual learning modality, wherein the first visual coding comprises a first color coding and wherein each first and second models comprise a 1-unit cuboid, wherein the (−1) cation unit cuboid comprises one first well and the (−1) anion unit cuboid comprises one first post;
third and fourth models representing (+2) cation and (−2) anion, respectively, wherein each comprise a second visual coding for stimulating visual learning modality, wherein the second visual coding comprises a second color coding and wherein each third and fourth models comprise a 2-unit cuboid, wherein the (+2) cation 2-unit cuboid comprises two second wells and the (−2) anion 2-unit cuboid comprises two second posts;
fifth and sixth models representing (+3) cation and (−3) anion, respectively, wherein each comprise a third visual coding for stimulating visual learning modality, wherein the third visual coding comprises a third color coding, and wherein each fifth and sixth models comprise a 3-unit cuboid, wherein the (+3) cation 3-unit cuboid comprises three third wells and the (−3) anion 3-unit cuboid comprises three third posts; and
wherein the first, second, third, fourth, fifth, or sixth models are adaptable to fit together to form a tactile cuboid having 6 faces and 8 corners, the tactile cuboid having one or two color coding therein representing a valid ionic compound.

17. The cross learning modality ionic compound representation model as in claim 16 wherein:
the first and second models representing (+1) cation and (−1) anion, respectively, each comprise a first tactile coding for stimulating tactile learning modality, wherein the first tactile coding comprises a first tactile coding, wherein the first tactile coding comprises a first alignment groove;
the third and fourth models representing (+2) cation and (−2) anion, respectively, each comprise a second tactile coding for stimulating tactile learning modality, wherein the second tactile coding comprises a second tactile coding, wherein the second tactile code comprises a second alignment groove offset from the first alignment groove by a predetermined distance.

18. The cross learning modality ionic compound representation model as in claim 17 wherein the first and second alignment grooves each comprise a plurality of coded depressions, wherein die first, second, third, fourth, fifth, or sixth models are adaptable to form a tactile cuboid having 6 faces and 8 corners, the tactile cuboid aligned according to the plurality of coded depressions.
